(19) United States
(12) Patent Application Publication
(10) Pub. No.: US 2019/0266612 A1
(43) Pub. Date: Aug. 29, 2019

(54) SYSTEM AND METHOD FOR VERIFYING PRODUCTS USING BLOCKCHAIN

(71) Applicant: Walmart Apollo, LLC, Bentonville, AR (US)

(72) Inventors: Brian McHale, Oldham (GB); Daniel W. Young, Rogers, AR (US); Jennifer Northrup, Eureka Springs, AR (US); Richard C. McSorley, JR., Bentonville, AR (US); Christopher R. Heeney, Bella Vista, AR (US); Joseph Jurich, Molino, FL (US)

(73) Assignee: Walmart Apollo, LLC, Bentonville, AR (US)

(21) Appl. No.: 16/284,334

(22) Filed: Feb. 25, 2019

Related U.S. Application Data
(60) Provisional application No. 62/636,778, filed on Feb. 28, 2018.

(51) Int. Cl. G06Q 30/00; H04L 9/06; H04L 9/08; H04L 9/32

(52) U.S. Cl. CPC G06Q 30/0185; H04L 9/3268; H04L 9/0866; H04L 9/0637

(57) ABSTRACT

A method for determining a provenance of an item to be sold on a marketplace is provided. The method includes: generating, by a first computer, a blockchain for the item to be sold on the marketplace; storing the blockchain of the item on the first computer; receiving, by the first computer, from a second computer a request of determining the provenance of the item; in response to the request, sending, by the first computer, to the second computer the blockchain of the item; receiving, by the second computer, the blockchain of the item from the first computer; analyzing, by the second computer, the blockchain of the item in accordance to the set of access authorization levels; and determining, by the second computer, based on the analyzation, whether the item has an acceptable provenance.

### CROSS-REFERENCED TO RELATED APPLICATION

This application claims the benefit of U.S. Provisional Patent Application No. 62/636,778, filed Feb. 28, 2018, which is incorporated herein by reference in its entirety.

### BACKGROUND

### 1. Technical Field

The present disclosure relates to blockchain technology, and more specifically to a system and method for verifying items using blockchain.

### 2. Introduction

Blockchain is a shared and distributed ledger that may facilitate the process of recording transactions and tracking assets in a peer-to-peer network. An asset may be tangible (e.g., an item, a house, a car, a TV, a camera, and so on). An asset may also be intangible like intellectual property (IP), such as patents, copyrights, or branding. For example, a blockchain-based item system may facilitate tracking ownership of an item such that every participant can access, monitor, and analyze the state of the item irrespective of where it is within its life cycle.

### SUMMARY

A method for determining a provenance of an item to be sold on a marketplace is provided. The method includes: generating, by a first computer, a blockchain for the item to be sold on the marketplace, wherein blocks of the blockchain contain at least one of: weight of the item, dimensions of the item, information regarding components of the item, a serial number of the item, a work order number for a batch of the item, a lot number of the item, a batch number of the item, return data of the item, and refurbished data of the item, and wherein each block of the blocks of the blockchain is specified at one of a set of access authorization levels; storing the blockchain of the item on the first computer; receiving, by the first computer, from a second computer a request of determining the provenance of the item; in response to the request, sending, by the first computer, to the second computer the blockchain of the item; receiving, by the second computer, the blockchain of the item from the first computer; analyzing, by the second computer, the blockchain of the item in accordance to the set of access authorization levels, wherein the analyzing includes retrieving data of the item from the blocks of the blockchain, and comparing the retrieved data of the item with data of a verified genuine item; and determining, by the second computer, based on the analyzation, whether the item has an acceptable provenance, wherein the determining includes checking whether the retrieved data of the item is acceptably consistent with the data of the verified genuine item, based on the comparison of the retrieved data of the item with the data of the verified genuine item; and if the retrieved data of the item is checked to be acceptably consistent with the data of the verified genuine item, determining the item to have an acceptable provenance.

A system for determining a provenance of an item to be sold on a marketplace is provided. The system includes a first computer configured to: generate a blockchain for the item to be sold on the marketplace, wherein blocks of the blockchain contain at least one of: weight of the item, dimensions of the item, information regarding components of the item, a serial number of the item, a work order number for a batch of the item, a lot number of the item, a batch number of the item, return data of the item, and refurbished data of the item; and each block of the blocks of the blockchain is specified at one of a set of access authorization levels; store the blockchain of the item on the first computer; receive, from a second computer, a request of determining the provenance of the item; and in response to the request, send to the second computer the blockchain of the item; and the second computer configured to: send the request of determining the provenance of the item to the first computer; receive the blockchain of the item from the first computer; analyze the blockchain of the item in accordance to the set of access authorization levels, wherein the analyzing includes retrieving data of the item from the blocks of the blockchain, and comparing the retrieved data of the item with data of a verified genuine item; and determine, based on the analyzation, whether the item has an acceptable provenance, wherein the determining includes checking whether the retrieved data of the item is acceptably consistent with the data of the verified genuine item, based on the comparison of the retrieved data of the item with the data of the verified genuine item; and if the retrieved data of the item is checked to be acceptably consistent with the data of the verified genuine item, determining the item to have an acceptable provenance.

A non-transitory computer-readable storage medium configured as disclosed herein can have instructions stored which, when executed by a computing device, cause the computing device to perform operations for determining a provenance of an item to be sold on a marketplace is provided. The instruction includes: generating, by a first computer, a blockchain for the item to be sold on the marketplace, wherein blocks of the blockchain contain at least one of: weight of the item, dimensions of the item, information regarding components of the item, a serial number of the item, a work order number for a batch of the item, a lot number of the item, a batch number of the item, return data of the item, and refurbished data of the item, and wherein each block of the blocks of the blockchain is specified at one of a set of access authorization levels; storing the blockchain of the item on the first computer; receiving, by the first computer, from a second computer a request of determining the provenance of the item; in response to the request, sending, by the first computer, to the second computer the blockchain of the item; receiving, by the second computer, the blockchain of the item from the first computer; analyzing, by the second computer, the blockchain of the item in accordance to the set of access authorization levels, wherein the analyzing includes retrieving data of the item from the blocks of the blockchain, and comparing the retrieved data of the item with data of a verified genuine item; and determining, by the second computer, based on the analyzation, whether the item has an acceptable provenance, wherein the determining includes checking whether the retrieved data of the item is acceptably consistent with the data of the verified genuine item, based on the comparison of the retrieved data of the item with the data of the verified genuine item; and if the retrieved data of the item is checked to be acceptably consistent with the data of the verified genuine item, determining the item to have an acceptable provenance.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates an exemplary block diagram of a transfer process of an item;

FIG. 2 illustrates an exemplary peer-to-peer network between a plurality of parties who involve the transfer process of the item;

FIG. 3 illustrates an exemplary blockchain based on interactions between the plurality of parties;

FIG. 4 illustrates an exemplary method of verifying an item based on blockchain; and

FIG. 5 illustrates an exemplary computer system.

### DETAILED DESCRIPTION

Systems, methods, and computer-readable storage media configured according to this disclosure are capable of verifying an item based on, for example, a public or private distributed ledger, such as blockchain. For example, the blockchain can provide a level of confidence that an item is the correct item. The disclosed system may also provide a measure of assurance that an item is as represented.

Blockchain can allow a probe into the history of a particular item to determine that the item has an acceptable provenance. For example, a secure digital (SD) card that is relabeled and sold as 128 Mb may turn out to be 16 Mb. The distributed nature of blockchain records can make this very difficult to fake.

In some embodiments, the disclosed system may also be used as a criterion for inclusion into an online marketplace that may provide a selling and buying platform. In this case, blockchain records of an item may be analyzed. Unless the information of the item stored in the blockchain records matches with the information of the item provided by a seller, the item is not accepted for listing on the marketplace.

In some embodiments, in addition to blockchain that may be used for the provenance of an item, a video analytics system may be provided as an extra measure of assurance that the item is genuine. The disclosed system may verify item weight, dimensions, etc. Digital watermarking may also be included with the video analytics system, as could “microdots”. The video analytics system could demonstrate contents of the microdot on an item. This can be additional evidence that the items are authentic. As such, the disclosed system may take further steps to avoid counterfeit or otherwise questionable items.

In some embodiments, individual components of an item may be tracked to validate the item. For instance, a TV may have many parts or components (e.g., processor, memory, ports). The components can be tracked to verify that the TV is the correct item and includes the proper components and capabilities. For example, the disclosed system can check if a supplier uses different parts for a TV that is supposed to have x,y,z components but has x,y,a instead. This way, the provenance of the TV and the important components can be verified. For expensive items like large screen TVs, the packaging of the TV and the TV itself may feature digital watermarking or microdots with the TV serial number.

In some embodiments, when each component of an item goes through its manufacturing process, the component may be tagged or updated through a blockchain at each location. Each component may further have a component certificate from its manufacturer. The final item once assembled can have every component certificate associated with it, helping to prove that the final item is indeed a genuine item. In addition, the final item may also be provided an item certificate created by a manufacturer who assembles the final item using the components. These component certificates and the item certificate may be stored in each corresponding block of the blockchain by the corresponding manufacturers.

In some embodiments, the disclosed system may allow a customer to determine if a seller has the right to sell an item and avoid “fake” items. The disclosed system can show the provenance of the item and demonstrate that the seller has the right to sell the item.

In some embodiments, a manufacturer of an item may add a work order number for a batch of manufactured items to a blockchain. The manufacturer may add serial numbers (or lot numbers or batch numbers) to the blockchain if the item is so identified. A hash can be made from the work order number, serial number, lot number or batch number.

In some embodiments, the disclosed system may add information regarding the top-level components of an item (e.g., a TV) to the item's record in a blockchain, for example, main processor model and serial number, video processor model and serial number, camera model and serial number, and display model and serial number.

In some embodiments, a pre-owned item may be resold. When the item is returned, a block can be added to the blockchain which verifies that the item is transferred back to the supplier or seller. The disclosed system may also be used to verify an item's provenance before being allowed into a resale marketplace. In addition, the disclosed system may also include any test or operational review data (e.g., of a video game) that a refurbish center develops and adds to the blockchain.

By using blockchain to verify an item, access to item information that is authentic and whose “chain of title” is irrefutable, can be decentralized. The blockchain is tamper-evident. No parties can tamper with a transaction after it has been recorded to the blockchain. If a transaction is changed, a new transaction must be used to reverse the change, and both transactions are then visible. A single and shared blockchain can provide one place to go to determine the provenance of an item without disputes.

In some embodiments, one or more parties (e.g., raw material suppliers, component or part manufacturers, manufacturer of the final item, dealer of the item, seller of the item, refurbishing party of the item, etc.) involved with the transactions for the item may not want to reveal to other parties all information they logged into the blockchain. A blockchain-based system, (e.g., Ethereum system) may be used to allow the parties to secure their logged information in the system and set various authorized access levels to the other parties. For example, a manufacturer may not want to a customer to view information regarding the raw materials used for manufacturing the item.

In some embodiments, if a peer-to-peer network is permissioned for a blockchain, it can enable the creation of a parties-only network with proof that parties are who they say they are and that items (components, or raw materials) are exactly as represented. This may protect the disclosed system against tampering, fraud, and cybercrime.

In some embodiments, through the use of IDs and permissions, parties can specify which information details they want other parties to be permitted to view. For example, a raw material supplier may not want other parties to access the processing parameters of the raw material. A refurbishing party may not want some parties to review testing processes information for refurbishing the item. Also, permissions can be expanded for special party. For example, to determine the provenance of an item, customers or marketplace platform providers may be authorized to access to all the information recorded by all the parties in the blockchain.

In some embodiments, permissions and cryptography may be used to prevent unauthorized access to the peer-to-peer network and ensure that parties are who they claim to be. For example, the peer-to-peer network may only allow a manufacturer of an item, a wholesaler of the item, and a courier transporting the item, to access the peer-to-peer network by authenticating who they are. The authentication may be done by, for example, asking each involved party to submit verification and documentation. Privacy can be maintained through cryptographic techniques or data partitioning techniques to give parties selective visibility into the blockchain. For example, data partitioning can enable the process of logically or physically partitioning data into segments that are more easily maintained or accessed. Both the information regarding an item and the identity of parties who own the information can be masked. After conditions are agreed to, parties cannot tamper with a record of the item.

In some configurations, communications between the parties can take the form of a blockchain, where each request and response made by computers of parties can be added to the blockchain. As any party takes an action via their computers (sending a request, sending a response to a request), that action information is added to the blockchain. More specifically, the request, response, or other action is hashed into the previous blockchain. This new, updated blockchain is then distributed to the computers of other parties within the group.

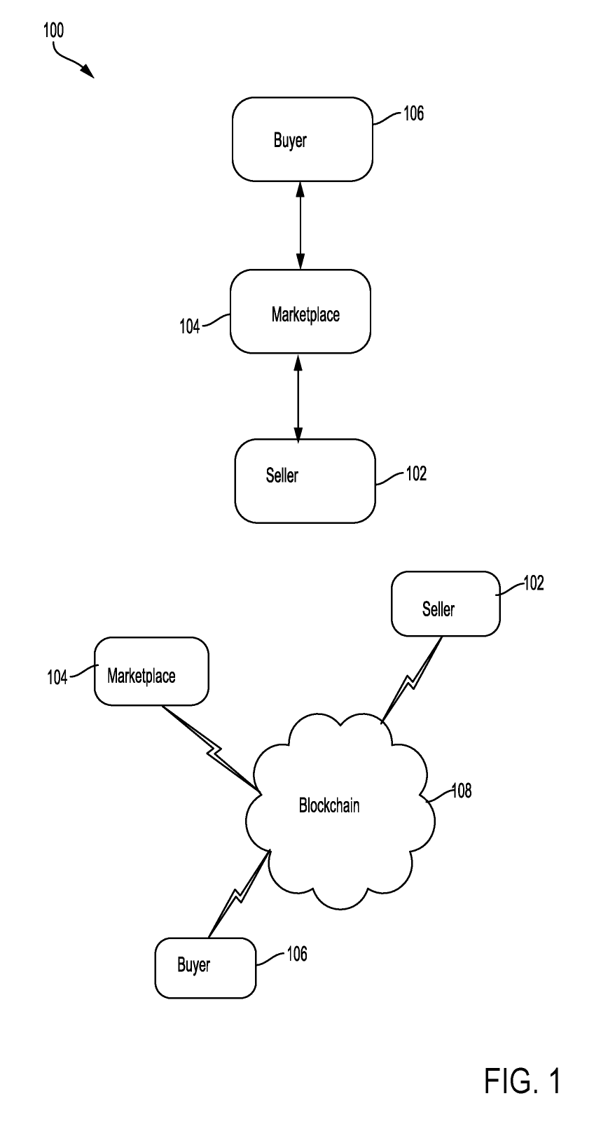

Various specific embodiments of the disclosure are described in detail below. While specific implementations are described, it should be understood that this is done for illustration purposes only. Other components and configurations may be used without parting from the spirit and scope of the disclosure, and can be implemented in combinations of the variations provided. These variations shall be described herein as the various embodiments are set forth. The disclosure now turns to FIG. 1.

FIG. 1 illustrates an exemplary block diagram of a transfer process 100 of an item. A seller 102 may want to sell the item on a platform provided by a marketplace 104. To verify the genuineness and provenance of the item, the marketplace 104 may request a verification of the item from the seller 102. The seller 102 may be one of parties involved in generating a blockchain of the item, so the seller 102 may have a copy of the blockchain. If the seller 102 does not have a copy of the blockchain, the seller 102 may further request the blockchain from another party involved with creating the blockchain, for example, an item dealer. The marketplace 104 may be authorized with partial or full access to the information details stored in the blockchain. The marketplace 104 may analyze the blockchain to determine the genuineness of the item. The marketplace 104 may further store its analysis results and determination in a side-chain attached to the blockchain. In some embodiments, the marketplace 104 may involve creating the blockchain, and thus maintain a copy of the blockchain.

A customer or buyer 106 may want to buy the item and also want to inquire the genuineness of the item. The customer 106 may request verification and be provided the blockchain of the item from the seller 102 or the marketplace 104. The customer 106 may be authorized with partial or full access to the information details stored in the blockchain. The customer 106 may analyze the blockchain to determine the genuineness of the item. Also, the customer 106 may probe into the blockchain having a side-chain attached by the marketplace 104, and confirm the provenance or the genuineness of the item by evaluating the information stored in the side-chain. The marketplace 104 may give the address or location of the side-chain for the customer 106 to verify, so the customer 106 may know where to obtain the desired information instead of searching the whole blockchain. In addition, to control access to the information in the blockchain, the customer 106 may not be able to access the remainder of the blockchain, for example, information regarding raw materials suppliers.

FIG. 1 also illustrates an example block diagram to show how the various parties generate/access the blockchain. The blockchain may be stored in a network 108. The network 108 may be a private network, a public network, and/or a cloud network. The seller 102 may be a manufacturer of the item to be sold on the marketplace. The manufacturer may store item information on the blockchain via, for examples, WIFI to access the network 108. The item information may include, but is not limited to, item manufacturing date and time, expiration date of the item, handing requirements of the items, warranty information of the item, terms and conditions, and so forth. The buyer 106 may access the blockchain to verify the item via, for example, WIFI to connect to the network 108. Similarly, the marketplace 104 may access the blockchain to verify the item via, for example, WIFI to connect to the network 108. In a case the marketplace is an item dealer, the marketplace may be involved in creating the blockchain.

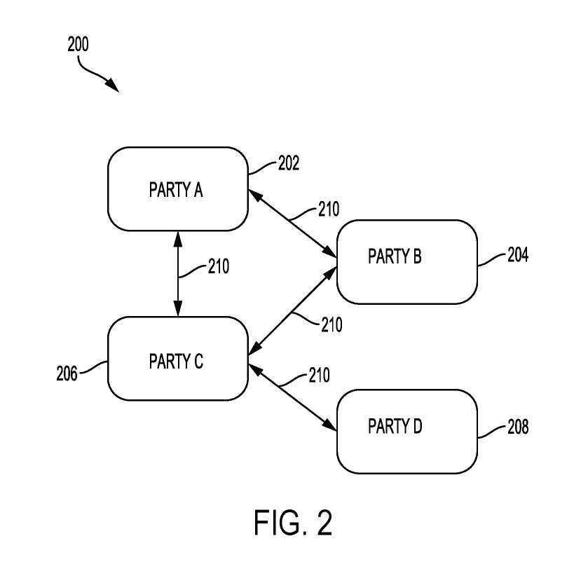

FIG. 2 illustrates an exemplary peer-to-peer network between a plurality of parties who involve the transfer process of the item. A peer-to-peer network such as that illustrated is a network where each node can relay data from and to other nodes within the network. While peer-to-peer networks can be constructed to operate in wired conditions, they are more prevalent in wireless configurations, where messages can be broadcast to other nearby nodes (i.e., not sent to a specific node, but rather all nodes within a given distance of the broadcasting node). When a receiving node is located outside the broadcast range of a transmitting node, intermediate nodes may be required to route the transmission to the receiving node. For example, as illustrated, node A (party A, e.g., a raw material supplier) 202 can communicate 210 with nodes B (party B, e.g., a component manufacturer of the item) 204 and C (party C, e.g., the item manufacturer) 206, and nodes B 204 and C 206 can communicate 210 with each other. However, nodes A 202 and B 204 cannot communicate with node D (party D, e.g., a seller or dealer of the item) 208. Because node D 208 can only communicate with node C 206, any communications 210 between node A 202 and node D 208, or between node B 204 and node D 208, must route through node C 206.

When developing an item, the various parties involved may communicate with one another via a peer-to-peer network 200. That is, the various parties may use devices at each node to transmit, receive, and relay messages between themselves as necessary. The devices used by the various parties may include, but not limited to, mobile phones, computing tablets, desktop computers, servers, laptop computers, smart phones, mainframes, and so forth.

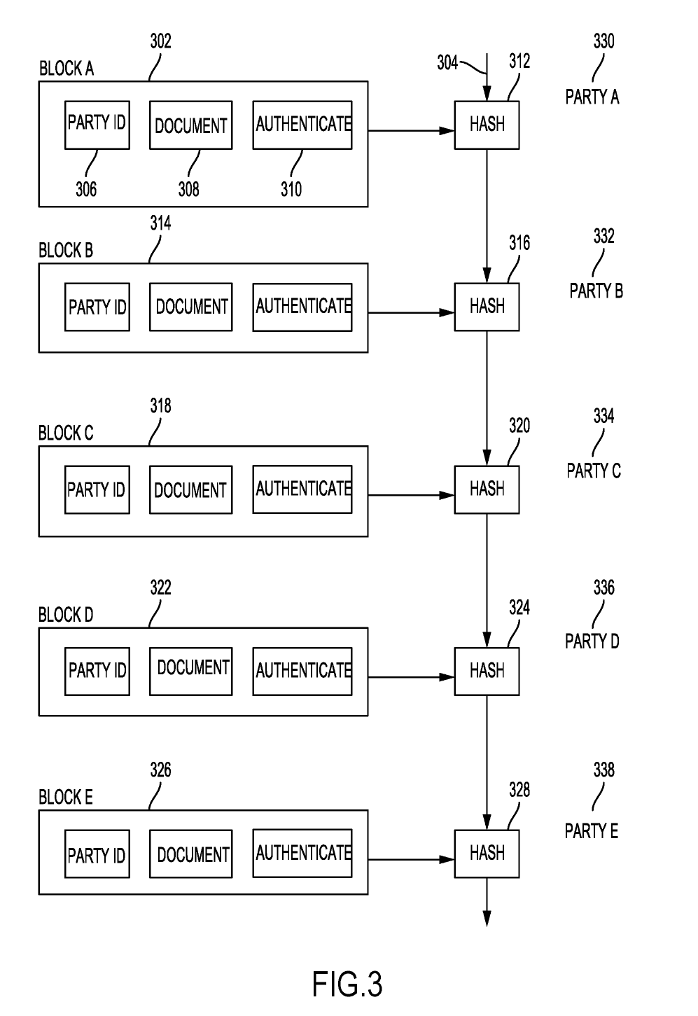

FIG. 3 illustrates an exemplary blockchain based on interactions between a plurality of parties for transferring the item using the network of FIG. 2. A blockchain is a distributed digital ledger which is communicated electronically between the parties. Each transaction recorded within the digital ledger is a block which can be hashed or otherwise encrypted. As new transactions are added to the digital ledger, each transaction's veracity can be tested against the previous ledger stored by the devices, and can, in some configurations, require confirmation from a defined percentage (usually 50%) of the devices to be added to the blockchain.

In the case of developing and transferring an item, the blockchain can take the form illustrated in FIG. 3. In this example, there is a blockchain 304 which is distributed among multiple parties. One of the parties, an initiating party (party A 330, e.g., a raw material supplier), may provide raw materials for making the item, and may store information of the raw materials in a block of the blockchain 304. In this example, a block (Block A 302) is generated to store the raw materials information and related data of party A 330. The block 302 added to the blockchain 304 may contains an ID 306 of party A 330, or an address or identification of a device that may be used by the party A 330, and the documents 308 containing raw material information. The raw material information may include, but not limited to, name and constitutes, processing parameters, purity, molecular formula and weight, safety sheet, and so forth. In addition, the block 302 can contain an authentication 310 portion. The authentication 310 portion may set restrictions of different levels on the documents 308 and the party ID 306. For example, the documents 308 and the party ID may be set not to be visible or accessible to other parties other than party A. The authentication 310 may authorize other parties to view a partial portion or details of the documents 308 and the party ID, for example, the title of a document. In addition, the authentication 310 may authorize full access to the documents 308 to a party, for example, an item buyer or seller, to analyze the documents 308.

As the party A generates the block 302, the block 302 is hashed 312 into the previous blockchain 304, resulting in an updated blockchain which is distributed among the parties in the group.

The other parties receive the updated blockchain containing the block 302. Another party, for example, party B 332 (e.g., an item component manufacturer) may also produce components of the item using the raw materials supplied by the party A 330. In this case, party B 332 generate a block 314 to store their documents and information related to the components in the blockchain 304. Similar to block 302, block 314 may store the component-related information documents and related data of party B 332, an ID of party B 332, or an address or identification of a device that may be used by the party B 332, and an authentication portion. The component documents and information may include, but is not limited to, component name and material, model number, serial number, dimensions, weight, electrical specifications, handling, shipping requirements, and so on.

As the party 332 generates the block 314, the block 314 is hashed 316 into the previous blockchain 304, resulting in an updated blockchain which is distributed among the parties in the group.

Similarly, Parties C 334 (e.g., a manufacturer of the item using the components) and D 336 (e.g., a seller or a dealer of the item) may also be involved in developing and transferring the item. Blocks 318 and 322 may be generated accordingly and hashed into the blockchain 304, resulting in an updated blockchain which is then distributed among the parties in the group. The document and information of the item manufacturer may include, but is not limited to, item name, dimensions, specification, manufacturing location, date and time, model number, serial number, etc. The document and information of the seller or dealer may include, but is not limited to, item inventory location, date, and time, item transportation company name, item transportation truck and driver, and so forth.

When the item is placed on a marketplace for sale, the marketplace (party E 338) may generate a block 326 and hashed 328 into the blockchain 304.

In some embodiments, a party who refurbishes the item may also add a block to the blockchain. The document and information in such block may include, replacement parts or components name and manufacturer, replacement location, date, time, replacement part model and serial numbers, testing results, performance evaluation, etc.

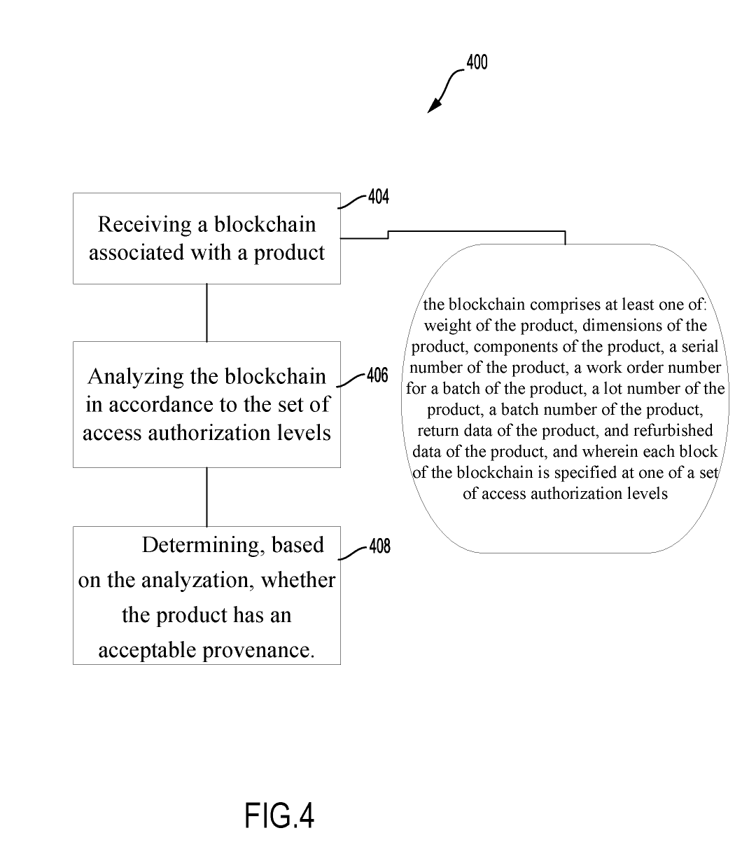

FIG. 4 illustrate an exemplary method 400 of verifying an item based on blockchain. The method 400 may be implemented in the system 200 of FIG. 2 and the blockchain of FIG. 3, and may comprise the following steps.

At step 404, a blockchain associated with an item is received, for example, by a computer of an item buyer or a marketplace that provides a platform for selling the item. As described above, the blockchain may be generated and updated via computers throughout the whole process from a manufacturer of the item to a seller of the item. The blockchain may be stored on any one of the computers from manufacturer of the item to the seller of the item. The computer of the buyer or the marketplace may send a request for determining the provenance of the item to the computer of the manufacturer or seller of the item. In response to the request, the computer of the manufacturer or the seller may send to the computer of the buyer or the marketplace the blockchain of the item. Accordingly, the computer of the buyer or the marketplace may receive the blockchain of the item from the computer of the manufacturer or the seller.

In some embodiments, the blockchain of the item to be sold on the marketplace may also be stored on a computer of the marketplace. The computer of the marketplace may receive from the computer of the buyer a request of determining the provenance of the item. In response to the request, the computer of the marketplace may send the blockchain of the item to the computer of the buyer. Accordingly, the computer of the buyer may receive the blockchain of the item from the computer of the marketplace.

The blockchain may comprise blocks containing information of the item including at least one of: weight of the item, dimensions of the item, components of the item, a serial number of the item, a work order number for a batch of the item, a lot number of the item, a batch number of the item, return data of the item, and refurbished data of the item, and wherein each block of the blockchain is specified at one of a set of access authorization levels.

At step 406, the blockchain is analyzed by the computer of the buyer or the marketplace in accordance to the set of access authorization levels. In such case, the buyer or the marketplace may be authorized to access some or all the item detailed information. The analyzing may include retrieving information of the item from the blocks of the blockchain, and comparing the retrieved information of the item with information of a verified genuine item.

At step 408, an acceptable provenance of the item may be determined, based on the analysis. The determining may include checking whether the retrieved information of the item is acceptably consistent with the information of the verified genuine item, based on the comparison of the retrieved information of the item with the information of the verified genuine item. If the retrieved information of the item is checked to be acceptably consistent with the information of the verified genuine item, the item may be determined to have an acceptable provenance.

The item may also be determined to be a genuine item or a fake item, for example, via the computer of the buyer or the marketplace to retrieve information of the item in the blockchain and to compare the information of the item with what is supposed to be (e.g., 128 mm long) to verify. The computer of the marketplace may allow or decline the item to be listed for sale based on the acceptable provenance. For a refurbished item, the computer of the buyer or the marketplace may consider the refurbished item acceptable even though some replacement parts are not the parts supplied by the original manufacturers.

In some embodiments, the blockchain may be incorporated into the marketplace. In this case, the marketplace may involve creating and updating the blockchain, for example, by adding a side-chain to the blockchain. The side-chain may or may not be unencrypted.

In some embodiments, the method 400 may further comprise receiving video analytics data of the item by the computer of the buyer from the computer of the manufacturer, seller or the marketplace. The video analytics data may include, but is not limited to, at least one of: whether a seal of the item is prematurely broken, whether the item is removed or exchanged during transfers of the item, digital watermarking of the item, and microdots of the item. In some embodiments, the video analytics data may be stored in blocks of a side-chain of the blockchain, and is unencrypted. Accordingly, the computer of the buyer may further analyze the received video analytics data of the item by using, for example, any suitable image or video analysis techniques.

In some embodiments, analyzing the blockchain by the computer of the buyer may further comprise tracking the components of the item, for example, by checking a certificate of each component. Each of the components of the item may be associated with a certificate from its corresponding manufacturer.

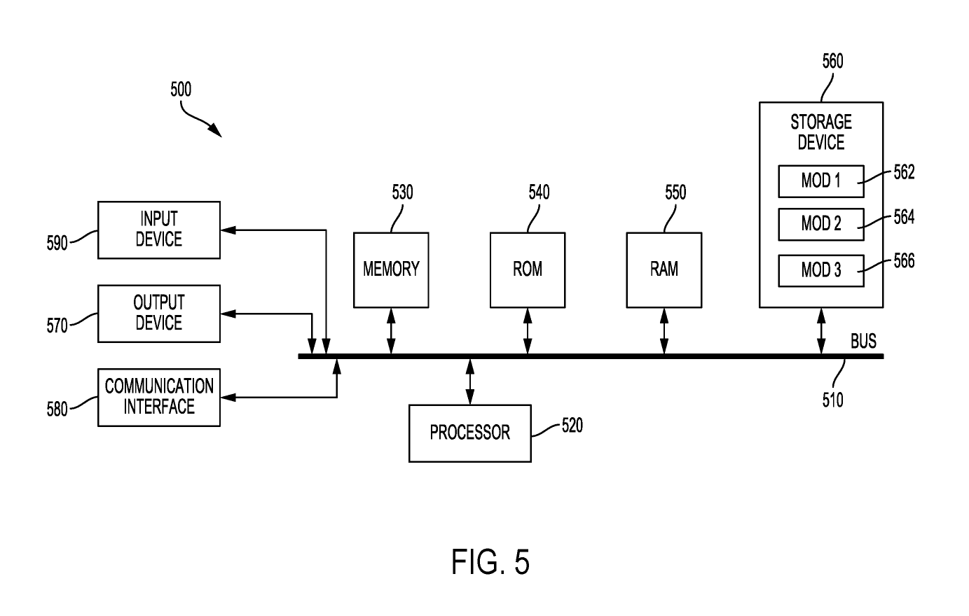

With reference to FIG. 5, an exemplary system 500 that may perform the disclosed systems and methods, can include a processing unit (CPU or processor) 520 and a system bus 510 that couples various system components including the system memory 530 such as read only memory (ROM) 540 and random access memory (RAM) 550 to the processor 520. The system 500 can include a cache of high speed memory connected directly with, in close proximity to, or integrated as part of the processor 520. The system 500 copies data from the memory 530 and/or the storage device 560 to the cache for quick access by the processor 520. In this way, the cache provides a performance boost that avoids processor 520 delays while waiting for data. These and other modules can control or be configured to control the processor 520 to perform various actions. Other system memory 530 may be available for use as well. The memory 530 can include multiple different types of memory with different performance characteristics. It can be appreciated that the disclosure may operate on a computing device 500 with more than one processor 520 or on a group or cluster of computing devices networked together to provide greater processing capability. The processor 520 can include any general purpose processor and a hardware module or software module, such as module 1 562, module 2 564, and module 3 566 stored in storage device 560, configured to control the processor 520 as well as a special-purpose processor where software instructions are incorporated into the actual processor design. The processor 520 may essentially be a completely self-contained computing system, containing multiple cores or processors, a bus, memory controller, cache, etc. A multi-core processor may be symmetric or asymmetric.

The system bus 510 may be any of several types of bus structures including a memory bus or memory controller, a peripheral bus, and a local bus using any of a variety of bus architectures. A basic input/output (BIOS) stored in ROM 540 or the like, may provide the basic routine that helps to transfer information between elements within the computing device 500, such as during start-up. The computing device 500 further includes storage devices 560 such as a hard disk drive, a magnetic disk drive, an optical disk drive, tape drive or the like. The storage device 560 can include software modules 562, 564, 566 for controlling the processor 520. Other hardware or software modules are contemplated. The storage device 560 is connected to the system bus 510 by a drive interface. The drives and the associated computer-readable storage media provide nonvolatile storage of computer-readable instructions, data structures, program modules and other data for the computing device 500. In one aspect, a hardware module that performs a particular function includes the software component stored in a tangible computer-readable storage medium in connection with the necessary hardware components, such as the processor 520, bus 510, display 570, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 500 is a small, handheld computing device, a desktop computer, or a computer server.

Although the exemplary embodiment described herein employs the hard disk 560, other types of computer-readable media which can store data that are accessible by a computer, such as magnetic cassettes, flash memory cards, digital versatile disks, cartridges, random access memories (RAMs) 550, and read only memory (ROM) 540, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 500, an input device 590 represents any number of input mechanisms, such as a microphone for speech, a touch-sensitive screen for gesture or graphical input, keyboard, mouse, motion input, speech and so forth. An output device 570 can also be one or more of a number of output mechanisms known to those of skill in the art. In some instances, multimodal systems enable a user to provide multiple types of input to communicate with the computing device 500. The communications interface 580 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

1. A blockchain-based method for determining a provenance of an item, comprising:
generating, by a first computer, a blockchain for the item, wherein blocks of the blockchain contain at least one of: weight of the item, dimensions of the item, information regarding components of the item, a serial number of the item, a work order number for a batch of the item, a lot number of the item, a batch number of the item, return data of the item, and refurbished data of the item, and wherein each block of the blocks of the blockchain is specified at one of a set of access authorization levels;
storing the blockchain of the item on the first computer;
receiving, by the first computer, from a second computer a request of determining the provenance of the item;
in response to the request, sending, by the first computer, to the second computer the blockchain of the item;
receiving, by the second computer, the blockchain of the item from the first computer;
analyzing, by the second computer, the blockchain of the item in accordance to the set of access authorization levels, wherein the analyzing includes retrieving data of the item from the blocks of the blockchain, and comparing the retrieved data of the item with data of a verified genuine item;
determining, by the second computer, based on the analyzing, whether the item has an acceptable provenance, wherein the determining includes checking whether the retrieved data of the item is acceptably consistent with the data of the verified genuine item, based on the comparison of the retrieved data of the item with the data of the verified genuine item; and if the retrieved data of the item is checked to be acceptably consistent with the data of the verified genuine item, determining the item to have an acceptable provenance, and
receiving, by the second computer from the first computer, video analytics data of the item,
wherein the analyzing further includes analyzing, by the second computer, the received video analytics data of the item,
wherein the video analytics data comprises at least one of: whether a seal of the item is prematurely broken, whether the item is removed or exchanged during transfers of the item, digital watermarking of the item, and microdots of the item,
wherein the video analytics data is stored in blocks of a side-chain of the blockchain, and is unencrypted.

2. The blockchain-based method of claim 1, further comprising:
storing, on a third computer, the blockchain of the item, wherein the first computer is associated with a manufacturer of the item and the third computer is associated with a marketplace;
receiving, by the third computer, from the second computer a request of determining the provenance of the item;
sending, by the third computer, to the second computer the blockchain of the item; and
receiving, by the second computer, the blockchain of the item from the third computer.

3. (canceled)

4. (canceled)

5. (canceled)

6. The blockchain-based method of claim 1, wherein the analyzing further includes tracking the components of the item by checking a certificate of each component.

7. The blockchain-based method of claim 1, wherein each of the components of the item is associated with a certificate from its corresponding manufacturer.

8. A system for determining a provenance of an item to be sold on a marketplace, comprising:
a first computer configured to:
generate a blockchain for the item to be sold on the marketplace, wherein blocks of the blockchain contain at least one of: weight of the item, dimensions of the item, information regarding components of the item, a serial number of the item, a work order number for a batch of the item, a lot number of the item, a batch number of the item, return data of the item, and refurbished data of the item; and each block of the blocks of the blockchain is specified at one of a set of access authorization levels;
store the blockchain of the item on the first computer;
receive, from a second computer, a request of determining the provenance of the item; and
in response to the request, send to the second computer the blockchain of the item; and
the second computer configured to:
send the request of determining the provenance of the item to the first computer;
receive the blockchain of the item from the first computer;
analyze the blockchain of the item in accordance to the set of access authorization levels, wherein the analyzing includes retrieving data of the item from the blocks of the blockchain, and comparing the retrieved data of the item with data of a verified genuine item;
determine, based on the analyzing, whether the item has an acceptable provenance, wherein the determining includes checking whether the retrieved data of the item is acceptably consistent with the data of the verified genuine item, based on the comparison of the retrieved data of the item with the data of the verified genuine item; and if the retrieved data of the item is checked to be acceptably consistent with the data of the verified genuine item, determining the item to have an acceptable provenance and wherein the second computer is further configured to:
receive from the first computer, video analytics data of the item; and
analyze the received video analytics data of the item, wherein the video analytics data is stored in blocks of a side-chain of the blockchain, and is unencrypted.

9. The system of claim 8, further comprising a third computer configured to:
store the blockchain of the item to be sold on the marketplace, wherein the first computer is associated with a manufacturer of the item and the third computer is associated with the marketplace;
receive, from the second computer, a request of determining the provenance of the item; and
in response to the request, send to the second computer the blockchain of the item;
wherein the second computer is further configured to:
send the request of determining the provenance of the item to the third computer; and
receive the blockchain of the item from the third computer.

10. (canceled)

11. The system of claim 8, wherein the video analytics data comprises at least one of: whether a seal of the item is prematurely broken, whether the item is removed or exchanged during transfers of the item, digital watermarking of the item, and microdots of the item.

12. (canceled)

13. The system of claim 8, wherein the analyzing further includes tracking the components of the item by checking a certificate of each component.

14. The system of claim 8, wherein each of the components of the item is associated with a certificate from its corresponding manufacturer.

15. A non-transitory computer-readable storage medium having instructions stored which, when executed by a computing device, cause the computing device to perform operations for determining a provenance of an item to be sold on a marketplace, comprising: generating, by a first computer, a blockchain for the item to be sold on the marketplace, wherein blocks of the blockchain contain at least one of: weight of the item, dimensions of the item, information regarding components of the item, a serial number of the item, a work order number for a batch of the item, a lot number of the item, a batch number of the item, return data of the item, and refurbished data of the item, and wherein each block of the blocks of the blockchain is specified at one of a set of access authorization levels;
storing the blockchain of the item on the first computer;
receiving, by the first computer, from a second computer a request of determining the provenance of the item;
in response to the request, sending, by the first computer, to the second computer the blockchain of the item;
receiving, by the second computer, the blockchain of the item from the first computer;
analyzing, by the second computer, the blockchain of the item in accordance to the set of access authorization levels, wherein the analyzing includes retrieving data of the item from the blocks of the blockchain, and comparing the retrieved data of the item with data of a verified genuine item;
determining, by the second computer, based on the analyzing, whether the item has an acceptable provenance, wherein the determining includes checking whether the retrieved data of the item is acceptably consistent with the data of the verified genuine item, based on the comparison of the retrieved data of the item with the data of the verified genuine item; and if the retrieved data of the item is checked to be acceptably consistent with the data of the verified genuine item, determining the item to have an acceptable provenance and receiving, by the second computer from the first computer, video analytics data of the item,
wherein the analyzing further includes analyzing, by the second computer, the received video analytics data of the item,
wherein the video analytics data is stored in blocks of a side-chain of the blockchain, and is unencrypted.

16. The non-transitory computer-readable storage medium of claim 15, wherein the instructions further cause the computer device to perform:
storing, on a third computer, the blockchain of the item to be sold on the marketplace, wherein the first computer is associated with a manufacturer of the item and the third computer is associated with the marketplace;
receiving, by the third computer, from the second computer a request of determining the provenance of the item;
sending, by the third computer, to the second computer the blockchain of the item; and
receiving, by the second computer, the blockchain of the item from the third computer.

17. (canceled)

18. The non-transitory computer-readable storage medium of claim 15, wherein the video analytics data comprises at least one of: whether a seal of the item is prematurely broken, whether the item is removed or exchanged during transfers of the item, digital watermarking of the item, and microdots of the item.

19. (canceled)

20. The non-transitory computer-readable storage medium of claim 15, wherein the analyzing further includes tracking the components of the item by checking a certificate of each component.
